(19) United States
(12) Patent Application Publication
(10) Pub. No.: US 2025/0096546 A1
(43) Pub. Date: Mar. 20, 2025

(54) Shear Pin Bracket for Aerial Cable System

(71) Applicant: Marmon Utility LLC, Milford, NH (US)

(72) Inventors: Grant BONCZAR, Milford, NH (US); Guberson MERCEDAT, Andover, MA (US); Sai Sowmith MADADI, Nashua, NH (US); Anubhav SINGH, Manchester, NH (US)

(73) Assignee: Marmon Utility LLC, Milford, NH (US)

(21) Appl. No.: 18/885,465

(22) Filed: Sep. 13, 2024

Related U.S. Application Data
(60) Provisional application No. 63/582,590, filed on Sep. 14, 2023.

(51) Int. Cl. H02G 7/04

(52) U.S. Cl. CPC H02G 7/04

(57) ABSTRACT

An apparatus for retaining a wire safely above ground in an overhead power distribution system that also prevents damage to a support structure caused by an object falling on the wire is disclosed herein. The apparatus may comprise a mounting base configured to be affixed to a support structure and a bracket arm configured to support a wire and rotatably engage the mounting base. The mounting base and the bracket arm may each include a set of apertures configured to receive a pivoting pin and a set of apertures configured to receive a shear pin. The bracket arm may be affixed to the mounting base in a horizontal position relative to the mounting base when the pivoting pin and shear pin are inserted into their corresponding apertures. The bracket arm rotates downward, pivoting around the pivoting pin, when the shear pin breaks due to impact on the wire.

### RELATED APPLICATIONS

This application claims priority to U.S. Provisional Patent Application No. 63/582,590, filed Sep. 14, 2023, the content of which is hereby incorporated herein by reference in its entirety.

### FIELD OF THE DISCLOSURE

The present invention relates to power distribution systems and, more particularly, to an overhead transmission and distribution wire bracket for retaining a wire safely above ground.

### BACKGROUND OF THE INVENTION

Brackets (fixturing devices) are essential components of any overhead transmission and distribution systems. Cables of such systems require one or more brackets to retain the cables to a utility support structure, such as a utility pole, tower, or other structure used to support one or more components of an overhead transmission and distribution system. These brackets must be constructed from durable, reliable, and long-lasting materials (such as steel) to ensure that the cables are retained on the utility support structure safely and for an extended period of time. The brackets must also be designed to retain the cables during inclement weather and other conditions where unwanted objects (or load) may fall onto the cables. For example, the brackets need to be designed for situations when a tree falls on a cable span.

However, conventional overhead transmission and distribution wire brackets (or fixturing devices) are so durable and sturdy that they typically hold the cables retained to the utility support structure, even when there is an impact (or force) from a falling object that is sufficiently strong enough to break the utility support structure. In other words, instead of detaching from the structure, the cables often remain attached, causing the support structure to break under the load and both the structure and cables to fall to the ground. For example, FIG. 1 depicts a pictorial view of an example prior art bracket or fixturing device 10—more specifically, an overhead transmission and distribution wire fixturing device-installed on a utility pole or tower. As depicted in FIG. 1, the conventional bracket or fixturing device 10 may be affixed to a utility support structure 12 at a first end 14 and extend away from the utility support structure 12 towards a wire support end 16 that includes a wire clamp 18 or similar device. A wire 20 may be retained within the wire clamp 18. The fixturing device 10 may include a reinforced body 22 which provides the fixturing device 10 substantial durability and strength in resisting bending, deformation, and/or breakage. A common design for the reinforced body 22 may include an I-beam design which provides significant resistance to impact forces from any direction, yet allows the fixturing device 10 to have a reduced weight as compared to a reinforced body 22 having a solid design. This substantial durability and strength of the reinforced body 22 gives the fixturing device 10 the ability to withstand most impact forces onto the wire 20.

However, as noted above, it has been found that conventional overhead transmission and distribution wire fixturing devices, similar to that depicted in FIG. 1, are so durable and sturdy that they commonly keep the wire retained to the utility support structure even when an impact force from a falling object is sufficiently strong enough to break the utility support structure. The utility support structure must then be replaced fully, along with the associated cables and wires, which becomes an expensive and timely process, not to mention the cost and potential commercial impact associated with a network being disconnected while the structures are restored. Retaining the cables safely while preventing the utility support structure from breaking would save significant effort, time, and money.

As such, there is a need for an improved system and method for retaining the cables safely while preventing the utility support structure from breaking during inclement weather or conditions when there is an impact caused by a falling object.

### SUMMARY OF THE INVENTION

Aspects of this disclosure relate to an apparatus for retaining a wire safely above ground in an overhead power distribution system that also prevents damage to a support structure to which the apparatus is affixed caused by an object falling on the wire. In various embodiments, the apparatus comprises an overhead transmission and distribution wire bracket. In various embodiments, the bracket may comprise a mounting base configured to be affixed to a support structure and a bracket arm configured to support a wire and rotatably engage the mounting base. In various embodiments, each of the mounting base and the bracket arm may include a set of apertures (or holes) configured to receive a pivoting pin and a set of apertures (or holes) configured to receive a shear pin. In various embodiments, the bracket arm may be affixed to the mounting base in a horizontal position relative to the mounting base (and the support structure) when the set of apertures configured to receive the pivoting pin are aligned and receive the pivoting pin and when the set of apertures configured to receive the shear pin are aligned and receive the shear pin. In various embodiments, the bracket arm is configured to rotate downward, pivoting around the pivoting pin, when the shear pin breaks due to impact on the wire. As such, the apparatus is configured to prevent additional damage to the support structure and the power distribution system during inclement weather and other conditions where unwanted objects (or load) may fall onto the cables.

In various embodiments, the mounting base may include one or more mounting openings via which the mounting base may be installed on a side of the support structure. In various embodiments, the bracket arm is configured to rotatably engage the mounting base at one end of the bracket arm and support the wire at an opposite end of the bracket arm. In various embodiments, the shear pin is designed to shear when the wire is impacted by a predetermined force determined based on a maximum load rating for the support structure. In some embodiments, the pivoting pin may have a larger diameter than the shear pin. In some embodiments, the mounting base may include a bumper configured to absorb impact forces on the mounting base from the bracket arm when the bracket arm rotates downward. In some embodiments, the bracket arm may include a spring extending downwardly from a bottom surface of the bracket arm. In such embodiments, the spring may be configured to absorb impact forces resulting from the bracket arm rotating downward and contacting the mounting base or the support structure. In some embodiments, the bracket arm may be positioned such that a spring extending downwardly from a bottom surface of the bracket arm contacts a bumper on the mounting base when the bracket arm rotates downward. In some embodiments, the mounting base may include a hanger opening configured to receive wires or ropes during installation. In some embodiments, the bracket arm may include a clamp at an end of the bracket arm opposite the mounting base when the bracket arm is affixed to the mounting base. In such embodiments, the clamp may be configured to secure the wire to the apparatus. In some embodiments, the mounting base may include a curved surface configured to mate with a rounded side of the support structure. In some embodiments, the apparatus may further comprise a retaining component configured to prevent a shear pin from moving outwardly away from the bracket arm (e.g., when the shear pin breaks due to impact force on the wire).

These and other objects, features, and characteristics of the systems and/or methods disclosed herein, as well as the methods of operation and functions of the related elements of structure and the combination thereof, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

The present invention is illustrated by way of example and not limited in the accompanying figures in which like reference numerals indicate similar elements and in which:

FIG. 1 depicts a pictorial view of an example prior art bracket installed on a utility support structure;

FIG. 2 depicts a perspective view of an example shear pin bracket, according to one or more aspects described herein;

FIG. 3A depicts a perspective view of an example shear pin, according to one or more aspects described herein;

FIG. 3B depicts a perspective view of a shear pin inserted into an example shear pin bracket, according to one or more aspects described herein;

FIGS. 4A-C depict various views of an example mounting base of a shear pin bracket, according to one or more aspects described herein;

FIGS. 5A-C depict various views of an example horizontal arm of a shear pin bracket, according to one or more aspects described herein;

FIGS. 6A-B depict various perspective views of an example connecting member and an impact-absorbing member of a shear pin bracket, according to one or more aspects described herein;

FIGS. 7A-B depict perspective views of an example torsion spring-based bracket assembly, according to one or more aspects described herein;

FIG. 8 depicts a perspective view of an example extendable cable-based bracket assembly, according to one or more aspects described herein;

FIG. 9 depicts a perspective view of an example frictional slider-based bracket assembly, according to one or more aspects described herein; and

FIGS. 10A-B depict various perspective views of a shear pin bracket including an example retaining component configured to prevent a shear pin from moving outward away from the shear pin bracket, according to one or more aspects described herein.

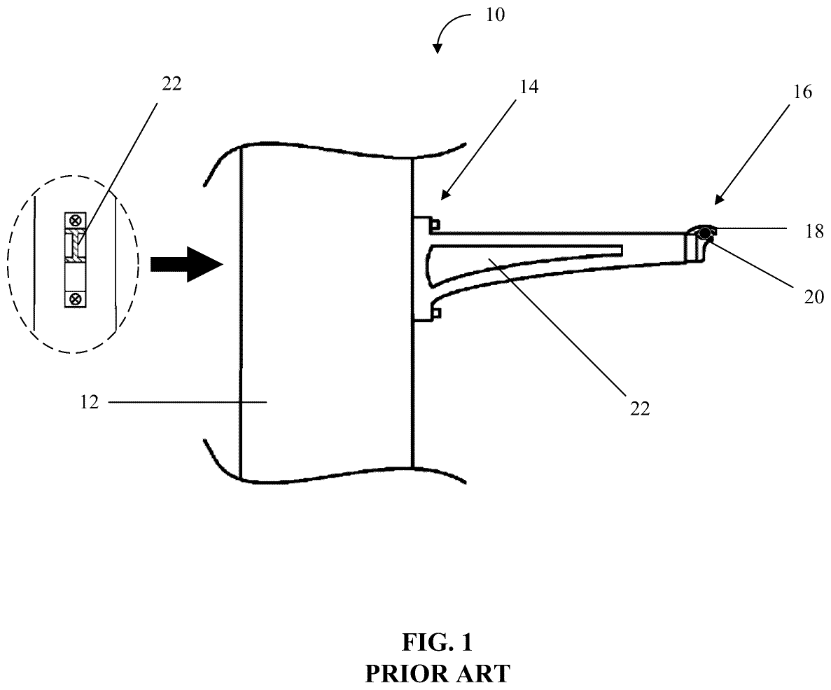

These drawings are provided for purposes of illustration only and merely depict typical or example embodiments. These drawings are provided to facilitate the reader's understanding and shall not be considered limiting of the breadth, scope, or applicability of the disclosure. For clarity and ease of illustration, these drawings are not necessarily drawn to scale.

### DETAILED DESCRIPTION

In the following description of various examples of the invention, reference is made to the accompanying drawings, which form a part hereof, and in which are shown by way of illustration various example structures, systems, and steps in which aspects of the invention may be practiced. It is to be understood that other specific arrangements of parts, structures, example devices, systems, and steps may be utilized, and structural and functional modifications may be made without departing from the scope of the present invention. Also, while the terms “top,” “bottom,” “front,” “back,” “side,” and the like may be used in this specification to describe various example features and elements of the invention, these terms are used herein as a matter of convenience, e.g., based on the example orientations shown in the figures. Nothing in this specification should be construed as requiring a specific three-dimensional orientation of structures in order to fall within the scope of this invention.

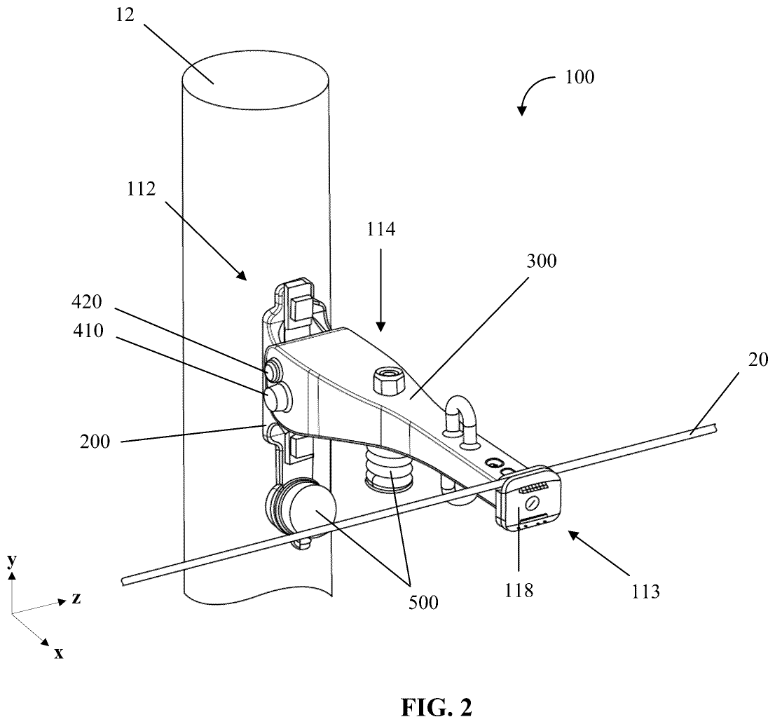

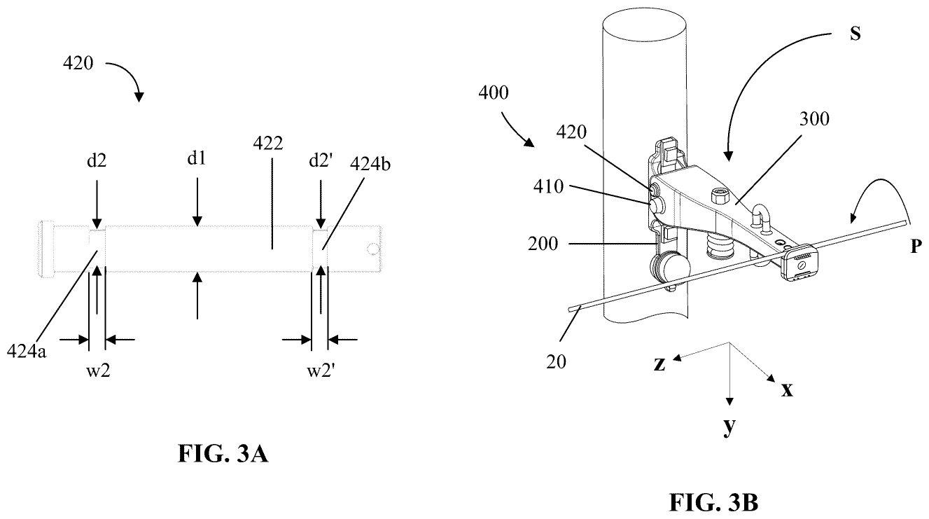

The invention described herein relates to an overhead transmission and distribution wire bracket for retaining the cables safely above the ground while preventing the utility support structure from breaking during inclement weather or conditions, for example, when there is an impact caused by the falling object. In various embodiments, the bracket described herein is configured to be affixed to a side of the utility support structure, such as a utility pole or tower. FIG. 2 depicts a perspective view of a shear pin bracket 100, according to one or more aspects described herein. In various embodiments, shear pin bracket 100 may comprise a mounting base 200 that may be connected to a utility support structure 12, a bracket arm 300, a pivoting pin 410, a shear pin 420, an impact-absorbing structure 500, and/or one or more other components. As described further herein (e.g., with respect to FIGS. 3A-B), pivoting pin 410 and shear pin 420 may each be inserted into mounting base 200 and bracket arm 300, and shear pin 420 may be configured to shear in response to an impact force on wire 20 and allow pivotal movement of bracket arm 300 relative to mounting base 200 around pivoting pin 410. In various embodiments, shear pin bracket 100 may include a pole end (or a utility support structure end) 112 and an opposite cable end (or a messenger cable resting portion) 113 along with a top surface end 114. These ends 112, 113, 114 may intersect to form a generally L-shaped configuration to allow top surface end 114 to be positioned generally perpendicular to a side of utility support structure 12 and opposite cable end (or a messenger cable resting portion) 113. In various embodiments, a wire 20 may be rested on or otherwise retained at opposite cable end 113 of shear pin bracket 100. For example, in various embodiments, wire 20 may be secured to opposite cable end 113 of the shear pin bracket 100 using one or more techniques described herein and/or using any other now known or future developed wire fastening technique. As used herein, wire 20 may comprise a messenger cable or any other wire or cable that might be included within an overhead transmission and distribution system (e.g., between utility structures).

In various embodiments, mounting base 200 of shear pin bracket 100 may be installed on a utility support structure 112 at pole end 112. In various embodiments, mounting base 200 may be affixed to the utility support structure 12 “vertically” from ground (i.e., along a y-axis), such that mounting base 200 may be mounted to the utility support structure 12 generally perpendicular to a ground plane (or x-z plane) and bracket arm extending plane (or x-y plane). In some embodiments, mounting base 200 may include a generally rectangular shape. The mounting base 200, however, may be of any appropriate shape, including, without limitation being generally circular or oval in shape.

In various embodiments, bracket arm 300 may include an elongated body that extends away from the mounting base 200 (or utility support structure 112) towards opposite cable end 113 that includes a wire support 118 and/or similar devices. In various embodiments, the bracket arm 300 may be positioned generally perpendicular to a wire 20 that extends horizontally (i.e., along a z-axis). In various embodiments, wire support 118 of bracket arm 300 may be positioned adjacent or otherwise in close proximity to wire 20 while allowing wire 20 to be rested on or secured to the bracket arm 300. In some embodiments, bracket arm 300 may include a generally rectangular shape. In other embodiments, however, bracket arm 300 may be of any appropriate shape, including generally circular or oval in shape.

FIG. 3A depicts a perspective view of example shear pin 420, and FIG. 3B depicts a perspective view of a shear pin inserted into a shear pin bracket 100, according to one or more aspects described herein. A shear pin (such as shear pin 420) is a “weak” pin designed to fail at specific loads. More specifically, a shear pin is a safety device designed to shear and fail in case of a mechanical overload, preventing other more expensive or “difficult-to-replace” parts from being damaged. For example, as a mechanical sacrificial part, it is analogous to an electric fuse. As depicted in FIG. 3A, in some embodiments, shear pin 420 may include a first shear pin diameter d1 at a shaft portion 422, a second shear diameter d2, d2′, and first and second shear width w2, w2′ at groove portions 424a, 424b. In various embodiments, shear pin 420 may be configured to shear at groove portions 424a, 424b when a mechanical load exceeds its load ratings. In some embodiments, the second shear diameter d2, d2′ and first and second shear width w2, w2′ of the shear pin 420 may be determined based on the required maximum load rating for different class poles.

In various embodiments, a shear pin 420 may be used with shear pin bracket 100 to shear in response to impact forces P, S to allow pivotal movement of the bracket arm 300 relative to the mounting base 200 around the pivoting pin 410. In various embodiments, mounting pole 12 may exhibit a high mechanical strength in the y-axis, but may exhibit a relatively low mechanical strength along the x-axis a primary impact direction P. In such embodiments, shear pin 420 may be extended along a z-axis (generally parallel to a wire or messenger cable) such that it is configured to fail at specific loads first, and thereby prevent greater damage or failure, such as utility support structure against the primary impact direction P (i.e., along x-y plane). For example, as shown in FIG. 3B, a falling tree may impact wire 20 with sufficient force along a primary impact direction P. The shear pin 420 (that extends along z axis) may prevent bracket arm 300 from rotating relative to the mounting base 200 around the pivoting pin 410. When the shear pin fails, the bracket arm 300 may rotate away from the impacting object about the pivoting pin 410. The rotation of the bracket arm 300 may reduce the risk to wire 20 and/or utility support structure 12. In various embodiments, shear pin 420 may have a smaller diameter than that of pivoting pin 410 to prevent other more expensive or “difficult-to-replace” parts (i.e., a utility support structure such as a utility pole or tower) from being damaged.

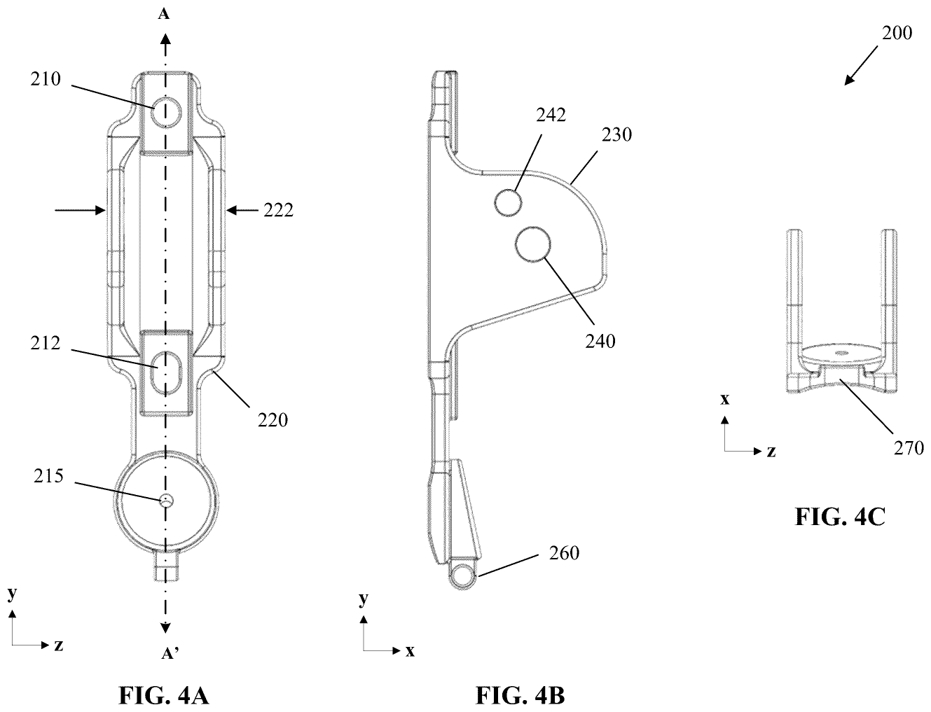

FIGS. 4A-C depict various views of a mounting base 200 of shear pin bracket 100, according to one or more aspects described herein. For example, FIG. 4A depicts a front view of mounting base 200 along a utility support structure plane (i.e., y-z plane), FIG. 4B depicts a side view of mounting base 200 as depicted in FIG. 4A along a line A-A′, and FIG. 4C depicts a top view of mounting base 200. In various embodiments, mounting base 200 may be installed on a side of a utility support structure (e.g., utility support structure 12). In various embodiments, mounting base 200 may include one or more mounting openings 210 configured to receive bolts, screws, and/or other types of fasteners to removably attach shear pin bracket 100 to a side of a utility support structure. In some embodiments, shear pin bracket 100 may be securely attached to a utility support structure via the one or more mounting openings 210 of mounting base 200 using one or more techniques described herein and/or using any other now known or future developed fastening technique. In various embodiments, mounting base 200 may include a slot 212 to address misalignment when drilled holes on the utility support structure are not aligned with one or mounting openings 210 of the mounting base 200. For example, slot 212 may be utilized to install shear pin bracket 100 to the utility support structure 12 when one or mounting openings 210 or drilled holes on the utility support structure are off centered by a small distance.

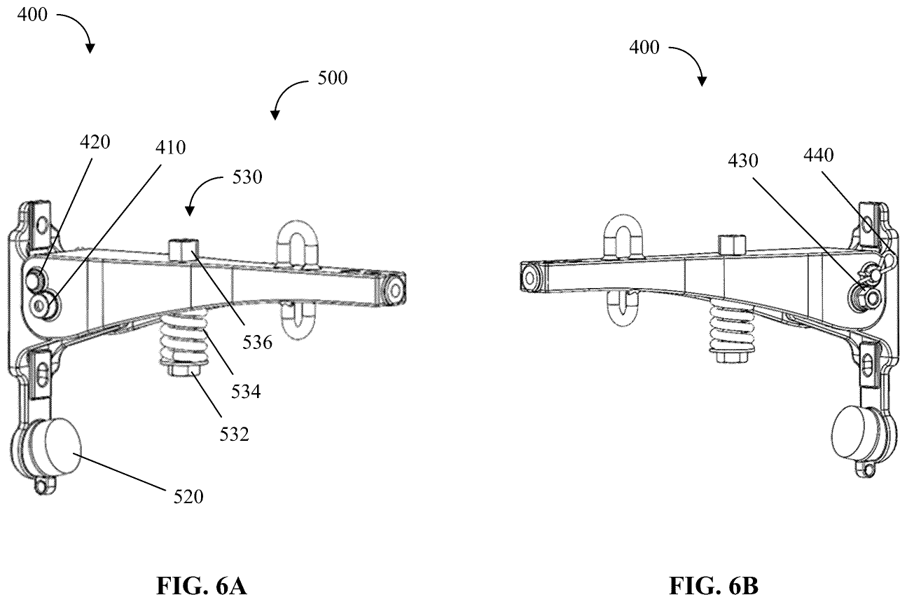

In various embodiments, mounting base 200 may include a bumper mounting opening 215 configured to receive an impact-absorbing bumper 520 (discussed in FIG. 6A) and via which impact-absorbing bumper 520 may be affixed to mounting base 200 (and shear pin bracket 100). In various embodiments, impact-absorbing bumper 520 may include a boss (i.e., with a cylindrical shape). In other embodiments, impact-absorbing bumper 520 may include a boss with a cylindrical shape with an angle.

In some embodiments, mounting base 200 may comprise a generally rectangular shape. In some embodiments, mounting base 200 may further include one or more portions with a horizontally varying curvature 220, as depicted in FIG. 4A. In various embodiments, the horizontally varying curvature may be present in portions of mounting base 200 extending along the y-axis. For example, a base width 222 of the mounting base 200 may be positioned for easy installation when connecting to and/or sliding into horizontal bracket arm 300 of shear pin bracket 100. In various embodiments, mounting base 200 may be preferably manufactured with a steel or metal selected for its mechanical strength/stress resistance and cost.

In various embodiments, mounting base 200 may be configured to rotatably engage horizontal arm 300 (also referred to interchangeably herein as “bracket arm 300”). In some embodiments, mounting base 200 and bracket arm 300 have a protruded (engaging) portion that engages mounting base 200 and horizontal bracket arm 300 together. In some embodiments, mounting base 200 and bracket arm 300 may include corresponding generally U-shaped cross-section engaging portions. For example, as shown in FIG. 4B, mounting base 200 may include a protruded portion curvature 230, so that the bracket arm 300 may rotate (or pivot) freely towards the mounting base 200 about pivoting pin aperture 240 without any interference

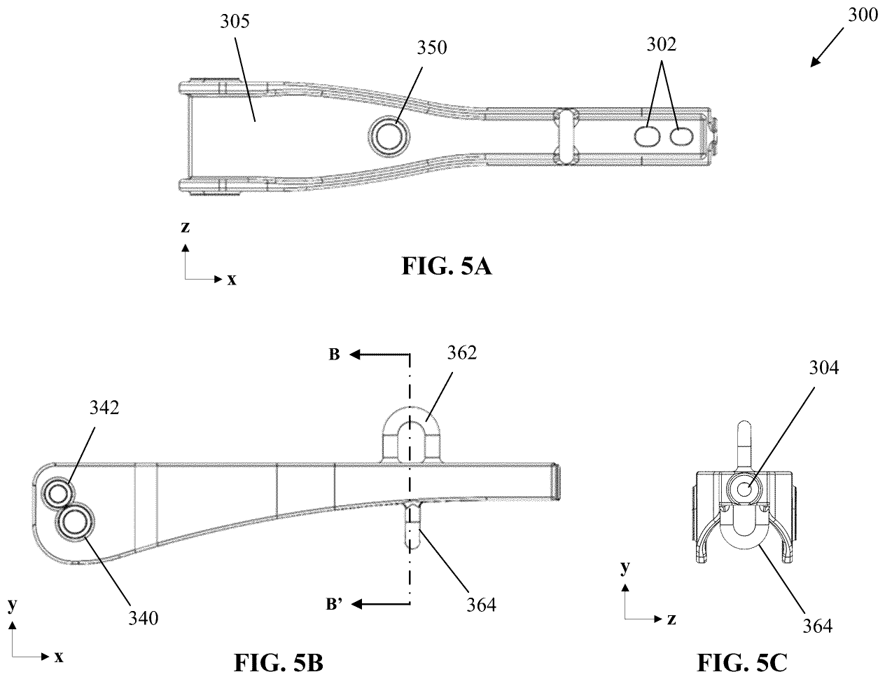

As depicted in FIG. 4B, in various embodiments, vertical mounting base 200 may include a pivoting pin aperture 240 and a shear pin aperture 242. In various embodiments, pivoting pin aperture 240 may receive a pivoting pin 410 (shown in FIG. 6A), and shear pin aperture 242 may receive a shear pin 420. The pivoting pin 410 with any appropriate configuration may be inserted through a pivoting pin aperture 240 and a corresponding pivoting pin aperture 340 (shown in FIG. 5B) of the bracket arm 300. In various embodiments, the pivoting pin 410 may be secured in place by a locking nut 430 (shown in FIG. 6B) for securing the bracket arm 300 with the vertical base 200 of the shear pin bracket 100, or any other appropriate method. The pivoting pin apertures 240, 340 may be of any configuration (such as generally circular in cross-sectional shape) to accept a pivoting pin (or a cotter pin). In various embodiments, mounting base 200 may include a hanger opening 260 that may be used to hang or attach any wires or ropes used during installation.

In various embodiments, a pivoting pin aperture 240 and a shear pin aperture 242 may include different diameters. In order for shear pin 420 at shear pin aperture 242 to fail at specific loads first and to prevent more expensive or “difficult-to-replace” utility support structure from being damaged, pivoting pin aperture 240 may include a larger diameter than that of shear pin aperture 242, for example, as shown in FIG. 4B. However, pivoting pin aperture 240 and shear pin aperture 242 may be of any appropriate size, configuration, and method that may be inserted therethrough using one or more techniques described herein and/or using any other now known or future developed fastening technique.

In various embodiments, bracket arm 300 may be rotatable (or pivotable) about pivoting pin aperture 240. In various embodiments, bracket arm 300 may be secured in a locked position via shear pin 420 with respect to the mounting base 200. In some embodiments, pivoting pin aperture 240 may act as a pivot point when there is an impact (or force caused by a falling object) that is sufficiently strong enough to break the shear pin 420 (shown in FIG. 6A), causing the bracket arm 300 to rotate (or pivot) towards the mounting base 200.

As depicted in FIG. 4C, in various embodiments, mounting base 200 may include a curved recess 270 extending along the z-axis. For example, a portion of the mounting base 200 may include a curved surface, so that the mounting base 200 may properly mate with the curved surface of the pole and have larger surface area of contact.

FIGS. 5A-C depict various views of a bracket arm 300 of shear pin bracket 100, according to one or more aspects described herein. For example, FIG. 5A depicts a bottom view of bracket arm 300 along a horizontal plane (i.e., x-z plane), FIG. 5B depicts a side view of bracket arm 300, and FIG. 5C depicts a front view of bracket arm 300 as depicted in FIG. 5B along a line B-B′. In various embodiments, bracket arm 300 may include a biasing opening 350 that may receive and securely attach an impact-absorbing biasing component 530 (depicted in FIG. 6A). In various embodiments, impact-absorbing biasing component 530 may comprise a biasing component 534 (e.g., a spring) configured to absorb the impact force. In various embodiments, an elongated arm body 305 of bracket arm 300 may include a threaded portion configured to receive an impact-absorbing fastener 532, a locking nut 536 (depicted in FIG. 6A), and/or a washer. In some embodiments, the threaded portion of elongated arm body 305 may be mated with impact-absorbing fastener 532 using any appropriate configuration. For example, impact-absorbing fastener 532 may be any appropriate fastening component. In various embodiments, bracket arm 300 may include one or more bracket openings 302 configured to receive and attach any apparatus used by bracket arm 300. For example, the one or more bracket openings 302 may be configured to attach any type of apparatus that may be needed to hang spacers and/or cables from bracket arm 300.

As shown in FIG. 5B, bracket arm 300 may include a pivoting pin aperture 340 configured to receive a pivoting pin 410. A pivoting pin 410 with any appropriate configuration may be inserted through a corresponding pivoting pin aperture 240 in bracket arm 300. The pivoting pin 410 may be secured in place by a locking nut 430 for securing the bracket arm 300 of the shear pin bracket 100 with vertical base 200, or any other appropriate method, such as a lock and lock body. The pivoting pin apertures 240, 340 may be of any configuration, such as being generally circular in cross-sectional shape, to accept a pivoting pin (or a cotter pin).

In various embodiments, a pivoting pin aperture 340 and a shear pin aperture 342 of bracket arm 300 may include different diameters. In order for shear pin 420 to fail at shear pin aperture 342 first at specific loads and prevent more expensive or “difficult-to-replace” utility support structure from being damaged, pivoting pin aperture 340 may include a larger diameter than that of shear pin aperture 342. However, pivoting pin aperture 340 and shear pin aperture 342 may be of any appropriate size, configuration, and method that may be inserted therethrough using one or more techniques described herein and/or using any other now known or future developed fastening technique. In some embodiments, bracket arm 300 may include an upper hook 362 that may be used to lift bracket arm 300 during installation. In some embodiments, bracket arm 300 may include a lower hook 364 that may be used to hang an apparatus or other component, for example, during installation.

As shown in FIG. 5C, in various embodiments, bracket arm 300 may include a clamp opening 304 configured to receive clamp or any types of components used to secure the clamp or appropriate components to the bracket arm 300. For example, the clamp opening 304 may be configured to removably attach a messenger clamp to a side of bracket arm 300.

FIGS. 6A-B depict various perspective views of shear pin bracket 100, according to one or more aspects described herein. As depicted in FIG. 6A, in various implementations, shear pin bracket may include an impact-absorbing structure 500 comprising an impact-absorbing bumper 520, an impact-absorbing biasing component 530, and/or one or more other components. In various embodiments, connecting member 400 of shear pin bracket 100 may be configured to rotatably engage bracket arm 300 with mounting base 200. In various embodiments, connecting member 400 may include a pivoting pin 410, a shear pin 420, a locking nut 430, a cotter pin 440, and/or one or more other components.

In various embodiments, pivoting pin 410 may be inserted through a pivoting pin aperture 240 of mounting base 200 and a corresponding pivoting pin aperture 340 of bracket arm 300. For example, as shown in FIGS. 6A-B, a shoulder screw may be inserted and pass through the pivoting pin aperture 240 of mounting base 200 and corresponding pivoting pin aperture 340 of the bracket arm 300. The bracket arm 300 may rotate (or pivot) about the pivoting pin 410 towards the mounting base 200. In various embodiments, pivoting pin 410 may act as a pivot point when there is an impact (or force by a falling object) that is sufficiently strong enough to break the shear pin 420. In various embodiments, pivoting pin 410 may be secured in place by a locking nut 430 for securing the bracket arm 300 with vertical base 200 of shear pin bracket 100. In various embodiments, shear pin 420 may be secured in place by a cotter pin 440 to prevent lateral movement by shear pin 420.

In various embodiments, shear pin bracket 100 may be configured to include a shear pin 420 that may be configured to shear in response to an impact force to allow pivotal movement of bracket arm 300 relative to mounting base 200 around pivoting pin 410. In various embodiments, shear pin bracket 100 may be configured to include an impact-absorbing bumper 520 that may be configured to absorb impact forces from the bracket arm 300 that rotate the impacting object about the pivoting pin 410. In various embodiments, an impact-absorbing bumper 520 may include an elastomeric material, such as rubber, that allows impact-absorbing bumper 520 to deform elastically under impact so that energy may be absorbed and dissipated as the elastomeric material is compressed. In various embodiments, impact-absorbing bumper 520 may be customized to respond to a wide range of energy and type of impact. In some embodiments, impact-absorbing bumper 520 may include a boss (i.e., with a cylindrical shape). In other embodiments, impact-absorbing bumper 520 may include a boss with a cylindrical shape with an angle (for example, as depicted in FIGS. 6A-B).

In various embodiments, shear pin bracket 100 may include an impact-absorbing biasing component 530 comprising a biasing component 534 configured to absorb the impact force. In various embodiments, biasing component 534 may comprise a component (such as a compression spring) configured to compress due to an impact on utility support structure 12, vertical base 200, and/or impact-absorbing bumper 520 caused by a load on wire 20, and thus absorb all or a portion of the corresponding force and dampen the impact force transferred to utility support structure 12 (i.e., a utility pole or tower), thereby increasing the chances of saving the utility support structure from breakage or damage caused by such impact.

In various embodiments, biasing component 534 may comprise a compression force spring, a wave spring, or any other suitable type of spring. In various embodiments, an elongated arm body 305 of bracket arm 300 may include a threaded portion configured to receive an impact-absorbing biasing washer and/or an impact-absorbing fastener 532. The impact-absorbing biasing washer and/or impact-absorbing fastener 532 may be configured to securely fasten impact-absorbing biasing component 530 to bracket arm 300. In some embodiments, impact-absorbing biasing component 530 may be adjusted to maintain a predetermined impact force to the utility support structure. For example, impact-absorbing biasing component 530 may be adjusted according to the pole rating. In some embodiments, the threaded portion of elongated arm body 305 may be mated to impact-absorbing fastener 532 using any appropriate configuration. For example, impact-absorbing fastener 532 may be any appropriate fastening component. In an example embodiment, impact-absorbing fastener 532 may comprise a locking nut 536.

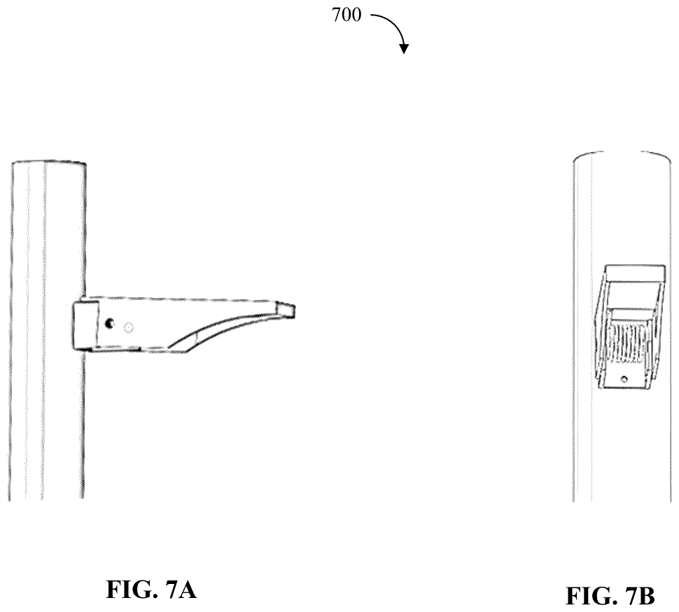

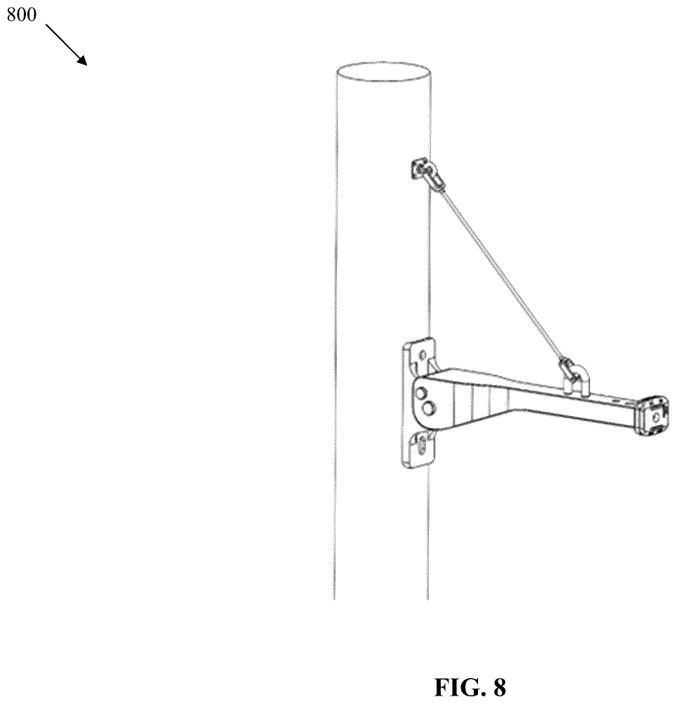

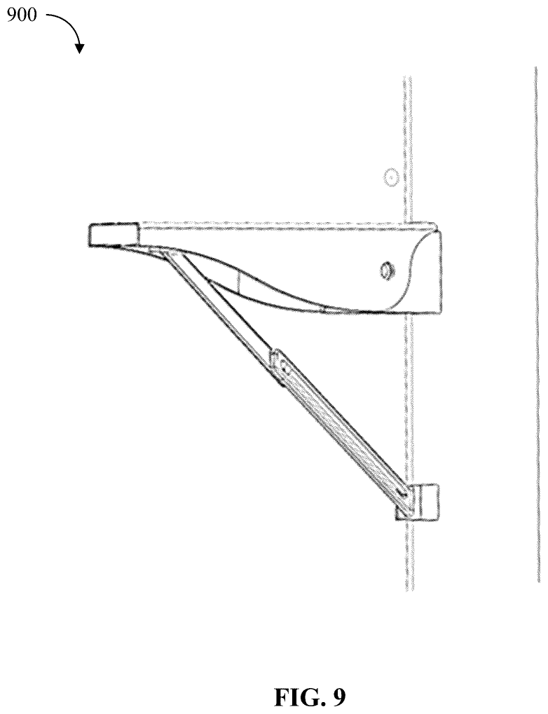

FIGS. 7A-B, 8, and 9 depict additional example embodiments of bracket assemblies for retaining cables of overhead transmission and distribution systems safely above the ground while preventing a corresponding utility support structure from breaking during inclement weather or conditions. For example, in some embodiments, a bracket assembly used according to the one or more objectives described herein may comprise a torsion spring-based bracket assembly 700, as depicted in FIGS. 7A-B. In other embodiments, a bracket assembly used according to the one or more objectives described herein may comprise an extendable cable-based bracket assembly 800, as depicted in FIG. 8. In other embodiments, a bracket assembly used according to the one or more objectives described herein may comprise a frictional slider-based bracket assembly 900, as depicted in FIG. 9. The components of the embodiments depicted in each of FIGS. 7A-B, 8, and 9 may be variously combined with other components described herein to form a single shear pin bracket 100 for use with a shear pin.

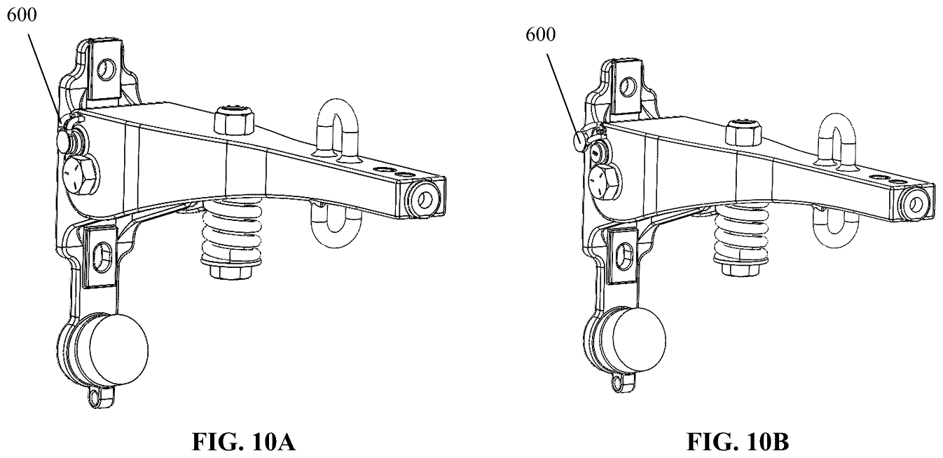

FIGS. 10A-B depict various perspective views of shear pin bracket 100 including a retaining component 600 configured to prevent a shear pin 420 from moving outward away from shear pin bracket 100, according to one or more aspects described herein. For example, FIG. 10A depicts a perspective view of shear pin bracket 100 with a retaining component 600 in an engaged position, and FIG. 10B depicts a perspective view of shear pin bracket 100 with a retaining component 600 in a disengaged position. As described herein (and depicted at least with respect to FIG. 2), a pivoting pin 410 may act as a pivot point when there is an impact (or force by a falling object) that is sufficiently strong enough to break the shear pin 420. When this occurs, some or all of shear pin 420 may be caused to be ejected outwardly from shear pin apertures 242, 342 and away from bracket arm 300. In such circumstances, the ejected shear pin 420 (or portion of shear pin 420) may represent a safety hazard and/or potentially cause damage to nearby structures, vehicles, and/or other nearby items. In various embodiments, shear pin bracket 100 may include a retaining component 600 configured to keep a shear pin 420 from moving outwardly away from shear pin bracket 100. In various embodiments, and as shown in FIGS. 10A-B, retaining component 600 may include a cap attached to bracket arm 300 and/or another component of shear pin bracket 100. In various embodiments, the cap may be configured to fit on an outside edge of shear pin 420 to prevent shear pin 420 from flying away from shear pin bracket 100. In some embodiments, a cap of retaining component 600 may be rotatably connected to bracket arm 300 (and/or another component of shear pin bracket 100) so that it may rotate between an engaged or disengaged position. For example, in a disengaged position, retaining component 600 may rotated such that a cap (or other portion configured to contact shear pin 420) does not cover or align with shear pin apertures 242, 342. As such, moving retaining component 600 to a disengaged position may reveal shear pin apertures 242, 342 in order to allow shear pin 420 to be inserted into shear pin apertures 242, 342. When a shear pin 420 is inserted into shear pin apertures 242, 342, retaining component 600 may be rotated (or freely rotate due to gravity) into an engaged position in which retaining component 600 is configured to prevent shear pin 420 from being removed or ejected from shear pin apertures 242, 342. In some embodiments, retaining component 600 may comprise one or more alternative mechanisms designed to prevent a shear pin 420 from moving outward away from shear pin bracket 100. In various embodiments, shear pin bracket 100 may include a retaining component 600 on one or both sides of shear pin bracket 100. In other words, a retaining component 600 may be included on one or both sides of the channel formed by shear pin apertures 242, 342.

It is to be understood that the invention is not limited in its application to the details of construction and the arrangement of the components set forth herein. The invention is capable of other embodiments and of being practiced or being carried out in various ways. Variations and modifications of the foregoing are within the scope of the present invention. It should be understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

While the preferred embodiments of the invention have been shown and described, it will be apparent to those skilled in the art that changes and modifications may be made therein without departing from the spirit of the invention, the scope of which is defined by this description.

Reference in this specification to “one embodiment”, “an embodiment”, “some embodiments”, “various embodiments”, “certain embodiments”, “other embodiments”, “one series of embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. An apparatus for retaining a wire safely above ground in an overhead power distribution system that prevents damage to a support structure caused by an object falling on the wire, the apparatus comprising:
a mounting base configured to be affixed to a support structure, the mounting base including at least a first set of apertures configured to receive a pivoting pin and a second set of apertures configured to receive a shear pin;
a bracket arm configured to support a wire and rotatably engage the mounting base, the bracket arm including a third set of apertures configured to receive the pivoting pin and a fourth set of apertures configured to receive the shear pin, wherein the bracket arm is affixed to the mounting base in a horizontal position relative to the mounting base and the support structure when the pivoting pin is inserted into the first set of apertures and the third set of apertures and the shear pin is inserted into the second set of apertures and the fourth set of apertures,
wherein the bracket arm is configured to rotate downward, pivoting around the pivoting pin, when the shear pin breaks due to impact on the wire.

2. The apparatus of claim 1, wherein the mounting base includes one or more mounting openings via which the mounting base may be installed on a side of the support structure.

3. The apparatus of claim 1, wherein the first set of apertures and the third set of apertures are configured to receive the pivoting pin when the first set of apertures and the third set of apertures are aligned, and wherein the second set of apertures and the fourth set of apertures are configured to receive the shear pin when the second set of apertures and the fourth set of apertures are aligned.

4. The apparatus of claim 1, wherein the bracket arm is configured to rotatably engage the mounting base at one end of the bracket arm and support the wire at an opposite end of the bracket arm.

5. The apparatus of claim 1, wherein the shear pin is designed to shear when the wire is impacted by a predetermined force determined based on a maximum load rating for the support structure.

6. The apparatus of claim 1, wherein the pivoting pin has a larger diameter than the shear pin.

7. The apparatus of claim 1, wherein the bracket arm comprises an elongated body that extends horizontally from the mounting base and the support structure when the bracket arm is affixed to the mounting base via the pivoting pin and the shear pin.

8. The apparatus of claim 1, wherein the mounting base includes a bumper configured to absorb impact forces on the mounting base from the bracket arm when the bracket arm rotates downward.

9. The apparatus of claim 1, wherein the bracket arm includes a spring extending downwardly from a bottom surface of the bracket arm, wherein the spring is configured to absorb impact forces resulting from the bracket arm rotating downward and contacting the mounting base or the support structure.

10. The apparatus of claim 1, wherein the mounting base includes a bumper, and the bracket arm includes a spring extending downwardly from a bottom surface of the bracket arm, wherein the bracket arm is positioned such that the spring contacts the bumper when the bracket arm rotates downward.

11. The apparatus of claim 1, wherein the mounting base includes a hanger opening configured to receive wires or ropes during installation.

12. The apparatus of claim 1, wherein the bracket arm includes a clamp at an end of the bracket arm opposite the mounting base when the bracket arm is affixed to the mounting base, wherein the clamp is configured to secure the wire to the apparatus.

13. The apparatus of claim 1, wherein the pivoting pin is secured in place in the first set of apertures and the third set of apertures via a locking nut.

14. The apparatus of claim 1, wherein the shear pin is secured in place in the second set of apertures and the fourth set of apertures via a cotter pin.

15. The apparatus of claim 1, wherein the mounting base includes a curved surface configured to mate with a rounded side of the support structure.

16. The apparatus of claim 1, the apparatus further comprising a retaining component configured to prevent a shear pin from moving outwardly away from the bracket arm.
